(19) United States
(12) Patent Application Publication
(10) Pub. No.: US 2025/0317554 A1
(43) Pub. Date: Oct. 9, 2025

(54) MERGING INTRA PREDICTION DATA FOR VIDEO CODING

(71) Applicant: QUALCOMM Incorporated, San Diego, CA (US)

(72) Inventors: Yao-Jen Chang, San Diego, CA (US); Vadim Seregin, San Diego, CA (US); Marta Karczewicz, San Diego, CA (US)

(21) Appl. No.: 19/171,928

(22) Filed: Apr. 7, 2025

Related U.S. Application Data
(60) Provisional application No. 63/631,871, filed on Apr. 9, 2024.
(60) Provisional application No. 63/656,856, filed on Jun. 6, 2024.
(60) Provisional application No. 63/681,982, filed on Aug. 12, 2024.

(51) Int. Cl. H04N 19/105; H04N 19/11; H04N 19/159; H04N 19/176; H04N 19/463; H04N 19/593; H04N 19/70

(52) U.S. Cl. CPC H04N 19/105; H04N 19/11; H04N 19/159; H04N 19/176; H04N 19/463; H04N 19/593; H04N 19/70

(57) ABSTRACT

Certain aspects of the disclosure provide for video coding that merges intra data from one or more neighboring blocks and reuses the intra data for a current block. An encoder can encode a syntax element that indicates the use of an intra merge mode for a block. A merge candidate list can be generated that comprises coding modes from one or more neighboring intra coded blocks and can store two or more parameters associated with at least one coding mode. The encoder can compute a template cost, reorder the candidate list based on cost, select a coding mode from the merge candidate list, and encode the current block using the select coding mode. A decoder can decode the syntax element, generate a merge candidate list, reorder the list, determine the coding mode based on the merge candidate list, and decode a current block utilizing the coding mode.

### CROSS-REFERENCE TO RELATED APPLICATIONS

This application claims the benefit of and priority to U.S. Provisional Application No. 63/631,871, filed Apr. 9, 2024, U.S. Provisional Application No. 63/656,856, filed Jun. 6, 2024, and U.S. Provisional Application No. 63/681,982, filed Aug. 12, 2024, the entire contents of each of which are hereby incorporated by reference.

### TECHNICAL FIELD

Aspects of the subject disclosure relate to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs), and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

The following summary provides a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, various methods, apparatuses, and systems related to improving video coding efficiency and performance are disclosed. Coding of a current block can involve merging intra data from neighboring blocks and reusing the intra data for coding. In accordance with one aspect, an encoder generates a syntax element to signal the use of intra merge mode. The encoder can then generate a merge candidate list including coding modes from neighboring intra-coded blocks and multiple associated parameters per mode. In some examples, the encoder can compute a template cost for each candidate, reorder the merge candidate list based on these costs, and select the optimal mode, ensuring the best fit for the current block. The decoder receives the syntax element, generates the merge candidate list, reorders the merge candidate list, determines the optimal coding mode, and decodes the current block utilizing the coding mode. Merging intra data, including two or more parameters for some intra prediction modes, and optimizing candidate coding mode selection can reduce redundancy, improve prediction accuracy, and enhance overall video quality.

In accordance with one aspect, a method of coding video data is disclosed. The method comprises determining, based on an intra merge mode, coding modes from one or more neighboring intra coded blocks of a current block, wherein at least a first coding mode of the coding modes from a first neighboring block comprises two or more parameters, generating, based on the intra merge mode, a merge candidate list comprising the coding modes from the one or more neighboring intra coded blocks, the merge candidate list storing the two or more parameters of the first coding mode from the first neighboring block, selecting the first coding mode from the merge candidate list, and coding the current block utilizing the first coding mode and the two or more parameters.

In accordance with another aspect, an apparatus configured to code video data is disclosed. The apparatus comprises one or more memories and processing circuitry in communication with the one or more memories. The processing circuitry is configured to determine, based on an intra merge mode, coding modes from one or more neighboring intra coded blocks of a current block, wherein at a first coding mode of the coding modes from a first neighboring block comprises two or more parameters, generate, based on the intra merge mode, a merge candidate list comprising the coding modes from the one or more neighboring intra coded blocks, the merge candidate list storing the two or more parameters of the first coding mode from the first neighboring block, select the first coding mode from the merge candidate list, and code the current block utilizing the first coding mode and the two or more parameters.

In accordance with yet another aspect, a computer-readable storage medium is disclosed having stored thereon instructions that, when executed, cause one or more processors to determine, based on an intra merge mode, coding modes from one or more neighboring intra coded blocks of a current block, wherein at least a first coding mode of the coding modes comprises two or more parameters, generate, based on an intra merge mode, a merge candidate list comprising the coding modes from the one or more neighboring intra coded blocks, the merge candidate list storing the two or more parameters of the first coding mode from the first neighboring block, select the first coding mode from the merge candidate list, and code the current block utilizing the first coding mode and the two or more parameters.

To the accomplishment of the foregoing and related ends, certain illustrative aspects of the claimed subject matter are described herein in connection with the following description and annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF DRAWINGS

The appended figures depict certain aspects and are therefore not to be considered limiting of the scope of this disclosure.

FIG. 1 is a block diagram illustrating an example video encoding and decoding system that may perform the techniques of this disclosure.

FIG. 2 illustrates example intra prediction modes that may be used in conjunction with the techniques of this disclosure.

FIG. 3 illustrates example neighboring blocks for constructing a most probable mode list that may be used in conjunction with the techniques of this disclosure.

FIG. 4 illustrates samples used in one example of decoder side intra mode derivation (DIMD) that may be used in conjunction with the techniques of this disclosure.

FIG. 5 illustrates samples used in one example of location-dependent DIMD that may be used in conjunction with the techniques of this disclosure.

FIG. 6 illustrates one example of fusion for template-based intra mode derivation (TIMD) that may be used in conjunction with the techniques of this disclosure.

FIG. 7 illustrates reference lines for one example of template-based multiple reference line intra prediction (TMRL) that may be used in conjunction with the techniques of this disclosure.

FIG. 8 illustrates one example of intra template matching (intraTMP) that may be used in conjunction with the techniques of this disclosure.

FIG. 9 illustrates one example of intraTMP fusion that may be used in conjunction with the techniques of this disclosure.

FIG. 10 illustrates one example of an intraTMP linear filter model that may be used in conjunction with the techniques of this disclosure.

FIG. 11 illustrates one example of an intraTMP sub-pel precision that may be used in conjunction with the techniques of this disclosure.

FIG. 12 illustrates an example of adjacent and non-adjacent neighboring blocks that may be used in conjunction with the techniques of this disclosure.

FIG. 13 illustrates example templates adjacent chroma coding units that may be used in conjunction with the techniques of this disclosure.

FIG. 14 is a block diagram illustrating an example video encoder that may perform the techniques of this disclosure.

FIG. 15 is a block diagram illustrating an example video decoder that may perform the techniques of this disclosure.

FIG. 16 is a flowchart illustrating an example method for encoding a current block in accordance with the techniques of this disclosure.

FIG. 17 is a flowchart illustrating an example method for decoding a current block in accordance with the techniques of this disclosure.

FIG. 18 is a flowchart illustrating an example method for coding a current block of video data in accordance with the techniques of this disclosure

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for performing video coding by merging intra data from neighboring blocks and reusing the intra data for coding a current block.

Aspects disclosed herein address these shortcomings with intra data merging. An encoder can encode a syntax element to signal the use of intra data merge mode and create a merge candidate list. The merge candidate list can include intra coding modes from neighboring blocks along with multiple associated parameters per mode. Further, the encoder can evaluate template cost per coding mode and reorder the merge candidate list. The template cost can be a measure of how well candidate coding mode prediction values match reconstructed video samples. The reordering can prioritize candidate coding modes with lower costs (e.g., better predictions) higher in the merge candidate list. The encoder can next select an intra coding mode for encoding a current block from the re-ordered merge candidate list. A decoder can perform a similar inverse process, including decoding a syntax element signaling the use of intra data merge mode, generating a merge candidate list, evaluating the template cost for each candidate coding mode in the merge candidate list, recording the merge candidate list based on the template cost, selecting a coding mode from the merge candidate list (e.g., based on a list index signaled by the encoder), and decoding video data with the selected coding mode. In accordance with one particular aspect the selected coding mode may include two or more parameters for the coding mode that are reused from a neighboring block.

Intra merge mode enhances efficiency by merging or reusing intra coding modes from neighboring blocks, minimizing redundancy. Further, intra merge mode lowers the bitrate as solely an index identifying a coding mode is transmitted rather than full coding mode information. Additionally, decoding is simplified as a decoder need only reconstruct a candidate list and retrieve the mode using a transmitted index. In this manner, computational complexity is reduced, accelerating encoding and decoding processes. Further, utilizing coding modes with more than one parameter can improve prediction accuracy by reducing prediction error and better capturing complex structures. Furthermore, merging or reusing coding modes from neighboring blocks reduces redundant information leading to improved compression efficiency and faster coding, among other things.

### Example Video Coding System

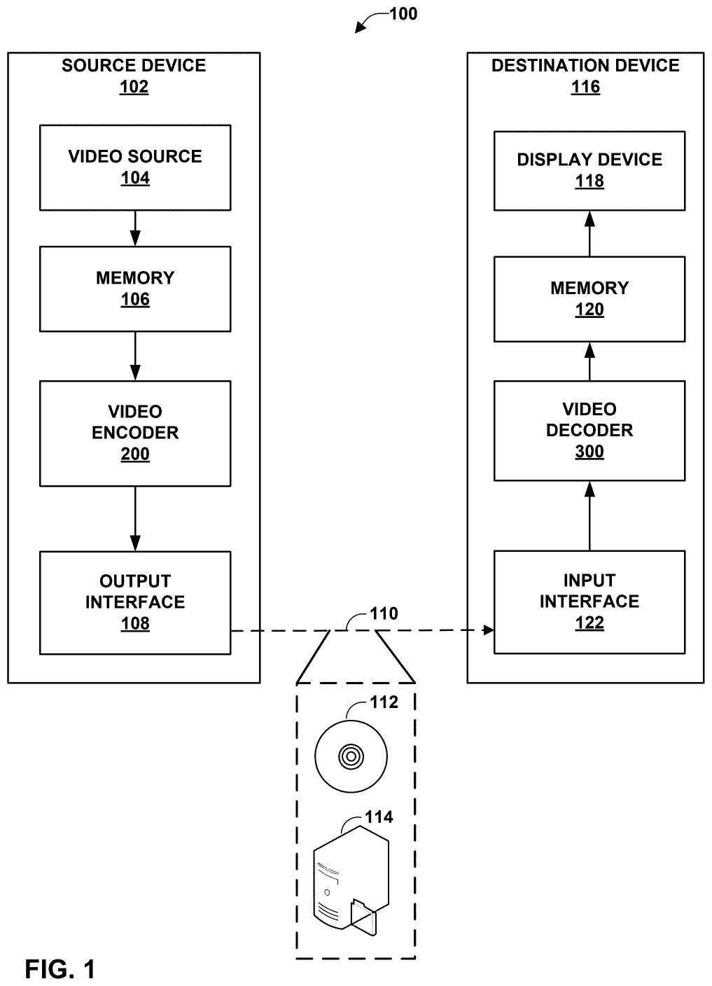

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication and, thus, may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for intra prediction. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100, as shown in FIG. 1, is merely one example. In general, any digital video encoding and/or decoding device may perform techniques for intra prediction as disclosed more specifically herein. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, for example for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec) and may include appropriate MUX-DEMUX units or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use intra prediction, for example, to merge intra data related to coding mode from neighboring blocks and reuse the intra data for coding a current block.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where Mis not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As will be discussed in more detail below, this disclosure describes techniques for merging intra prediction relate data from a plurality of different intra prediction or coding modes in a neighboring block. For example, in accordance with the techniques of this disclosure, video encoder 200 and video decoder 300 may determine, based on an intra merge mode, coding modes from one or more neighboring intra coded blocks of a current block, wherein at least a first coding mode of the coding modes from a first neighboring block comprises two or more parameters, generating, based on the intra merge mode, a merge candidate list comprising the coding modes from the one or more neighboring intra coded blocks, the merge candidate list storing the two or more parameters of the first coding mode from the first neighboring block, select the first coding mode from the merge candidate list, and code the current block utilizing the first coding mode and the two or more parameters.

Starting from April 2021, JVET has been developing an Enhanced Compression Model (ECM) software to enhance the compression capability beyond VVC. The set of coding tools in the ECM software encompasses functional blocks in a hybrid video coding framework, including intra prediction, inter prediction, transform and coefficient coding, in-loop filtering, and entropy coding. The techniques of this disclosure may be applied to ECM and state of the art video codecs, such as VVC, AV1, AV2, or any other codecs that use intra prediction.

### Example Intra Coding Tools

Selected intra coding tools used in current ECM are described below. Descriptions of more intra tools can be found in M. Coban, R.-L. Liao, K. Naser, J. Ström, and L. Zhang, “Algorithm description of Enhanced Compression Model 12 (ECM 12),” JVET-AG2025, March 2024.

### Most Probable Mode (MPM)

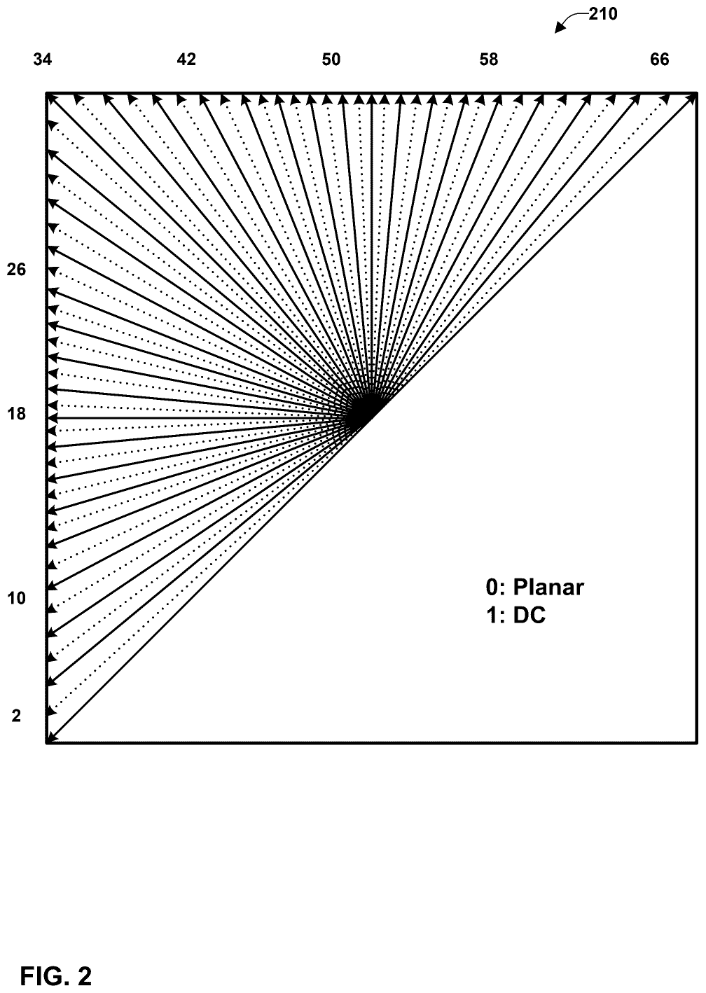

As illustrated in FIG. 2, intra modes may include Planar mode, DC mode, and 65 (or more) angular modes 210. FIG. 2 illustrates example intra prediction modes or coding modes that may be used in conjunction with the techniques of this disclosure.

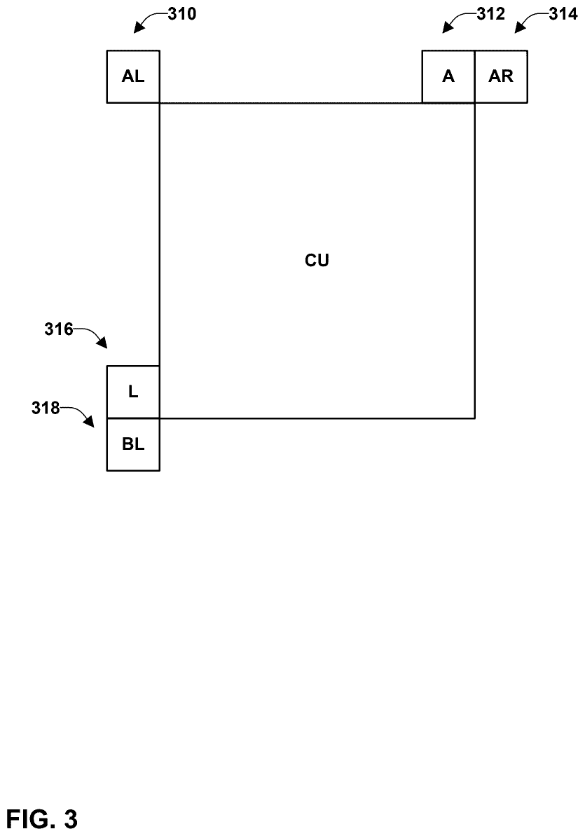

Video encoder 200 and video decoder 300 may construct an MPM list using Planar mode, the intra modes used in neighboring blocks of the current CU, decoder side intra mode derivation (DIMD) modes, and derived modes with added offset to existing angular mode in the list. FIG. 3 is one example that shows an above-left (AL) neighboring block 310, and above (A) neighboring block 312, an above-right (AR) neighboring block 314, a left (L) neighboring block 316, and a below-left (BL) neighboring block 318. A shorter bitstream is used for the intra modes in the MPM list to obtain a coding benefit.

### Decoder Side Intra Mode Derivation (DIMD)

When using DIMD, up to five DIMD modes are derived by analyzing the directionality of the content in the surrounding area of the current block. A Histogram of Gradients (HoG), as shown below, is computed on a three-sample wide/high L-shaped template formed of already reconstructed samples.

$$Gx = [ \begin{matrix}- 1 & 0 & 1 \\ - 2 & 0 & 2 \\ - 1 & 0 & 1\end{matrix} ] Gy = [ \begin{matrix}- 1 & - 2 & - 1 \\ 0 & 0 & 0 \\ 1 & 2 & 1\end{matrix} ]$$

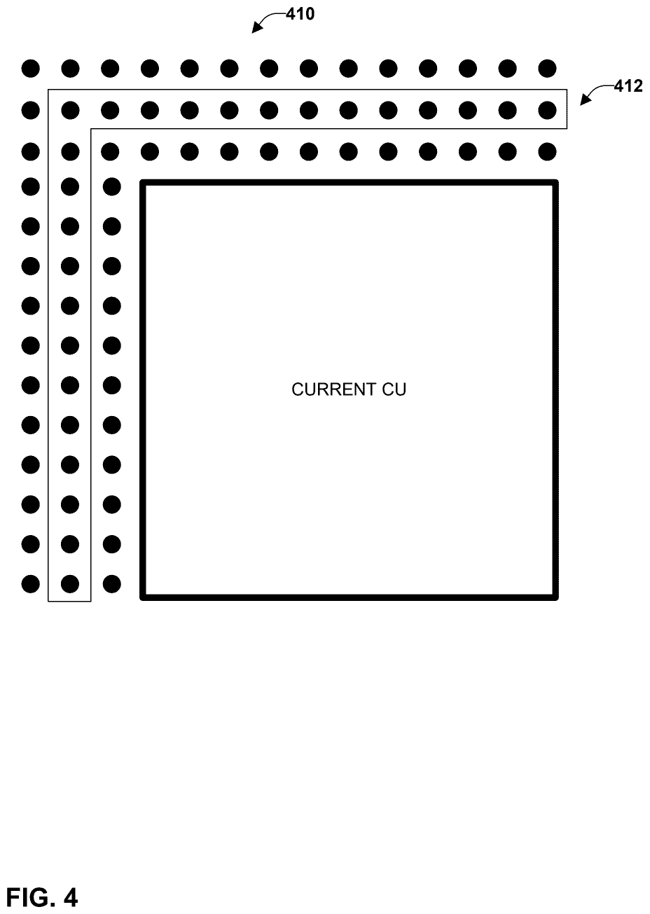

The HoG is obtained using a Sobel filter, accumulating the magnitudes of all gradients at a given direction, for all the samples 410 within region 412 in FIG. 4. FIG. 4 illustrates samples 410 used in one example of DIMD that may be used in conjunction with the techniques of this disclosure. Video encoder 200 and video decoder 300 may select the directions with highest cumulative magnitude as DIMD modes. Video encoder 200 and video decoder 300 may then blend the predictors obtained with the DIMD modes to form the final DIMD prediction.

### Location-Dependent DIMD

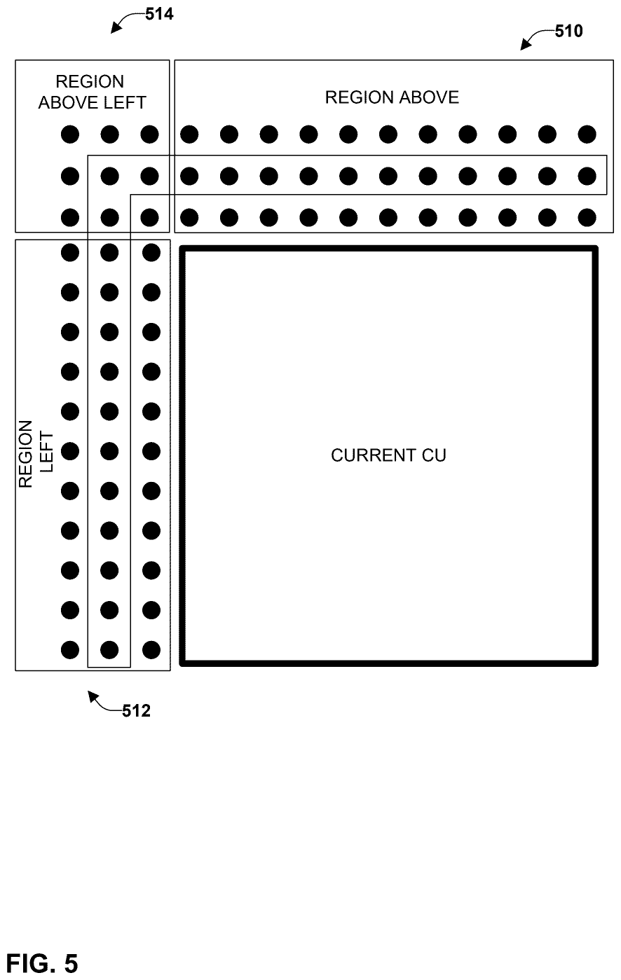

An example of location-dependent DIMD is described in S. Blasi, et. al., “EE2-1.8: Location-dependent DIMD,” Joint Video Experts Team (JVET) of ITU-T SG 16 WP 3 and ISO/IEC JTC 1/SC 29, 29th Meeting, by teleconference, 11-20 Jan. 2023 (hereinafter, “JVET-AC0098”). The gradient computation is performed separately for samples in each region, resulting in three histograms, H_above 510, H_left 512 and H_aboveLeft 514, respectively, as shown in FIG. 5. FIG. 5 illustrates samples used in one example of location-dependent DIMD that may be used in conjunction with the techniques of this disclosure.

The histograms H_above and H_left can be used to determine whether a DIMD mode dimdMode_i depends on a specific template region ABOVE or LEFT. There are three location dependent index (locDep_i) as shown below:
If (H [dimdMode_i]>3H_left [dimdMode_i]): locDep_i=1 (dimdMode_i depends on region ABOVE)
If (H [dimdMode_i]>3H_above [dimdMode_i]): locDep_i=2 (dimdMode_i depends on region LEFT)
Otherwise, locDep_i=0 (dimdMode_i is not location-dependent)

Each value of locDep_i leads to different DIMD predictions. More details can be found in JVET-AC0098.

### Occurrence-Based Intra Coding (OBIC)

An example of occurrence-based intra coding (OBIC) mode is described in R. Yoouvalari et al., “EE2-2.2: Occurrence-based intra coding (OBIC),” Joint Video Experts Team (JVET) of ITU-T SG 16 WP 3 and ISO/IEC JTC 1/SC 29, 34th Meeting, Rennes, FR, 17-24 Apr. 2024 (hereinafter, “JVET-AH0076”). According to the OBIC method, a video coder derives intra prediction modes for a block based on the occurrence of the intra modes in the spatial neighborhood of the block. Per the OBIC techniques, the video coder may use blending of up to five intra modes, with highest occurrence, along with planar mode or block vector based prediction, to obtain the prediction of the block. The video coder may determine blending weights based on each mode's occurrence in the neighborhood. Usage of the mode may be signaled with a CABAC-coded PU level flag. The OBIC mode is used as a sub-mode of DIMD, and its flag may be signaled after a DIMD flag.

### Fusion for Template-Based Intra Mode Derivation (TIMD)

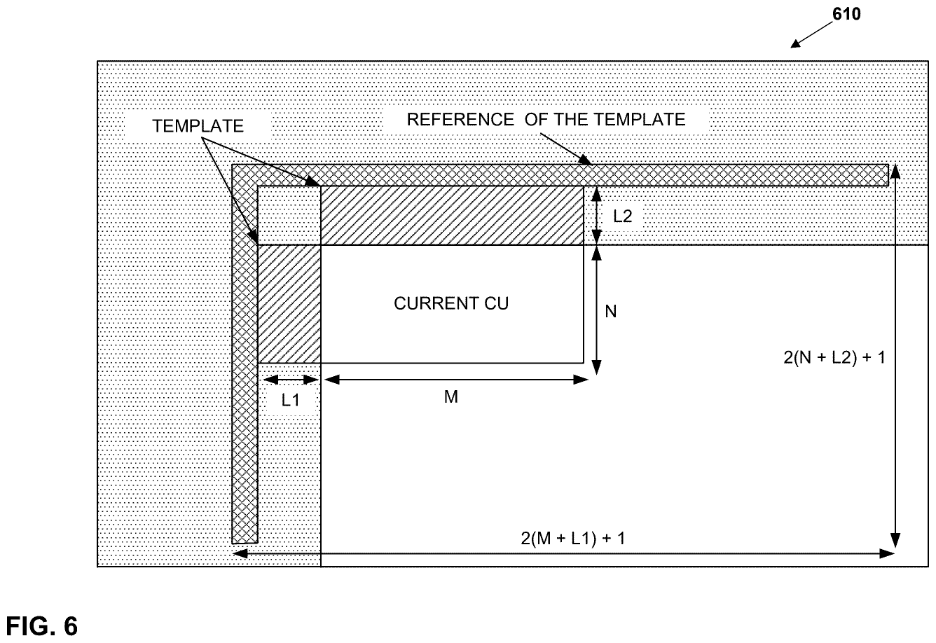

For each intra prediction mode in MPM lists, wide-angle, DC, horizontal, vertical, and extended modes, the sum of absolute transform differences (SATD) between the prediction and reconstruction samples of the template is calculated as shown in FIG. 6. FIG. 6 illustrates one example of fusion for template-based intra mode derivation (TIMD) 610 that may be used in conjunction with the techniques of this disclosure.

First two intra prediction modes (e.g., TIMD1, TIMD2) with the minimum SATD are TIMD modes that are selected for fusion.

If costMode2<2*costModel: the prediction is derived by weight1*Pred_TIMD1+weight2*Pred_TIMD2, where weight1=cost_TIMD2/(cost_TIMD1+cost_TIMD2), and weight2=1-weight1. Otherwise, the prediction is derived from TIMD1 only. A third non-angular TIMD mode (e.g., Planar or DC) may be applied in combination with Pred_TIMD1 and Pred_TIMD2.

### Template-Based Multiple Reference Line Intra Prediction (TMRL)

TMRL mode combines reference line and prediction mode together and uses a template matching method to construct a list of candidate combinations. An index to the candidate combination list is coded to indicate which reference line and prediction mode is used in coding the current block. More details can be found in L. Xu, et. al., “EE2-1.10: Template-based multiple reference line prediction,” Joint Video Experts Team (JVET) of ITU-T SG 16 WP 3 and ISO/IEC JTC 1/SC 29, 28th Meeting, Mainz, DE, 20-28-20 Oct. 2022 (hereinafter, “JVET-AB0156”).

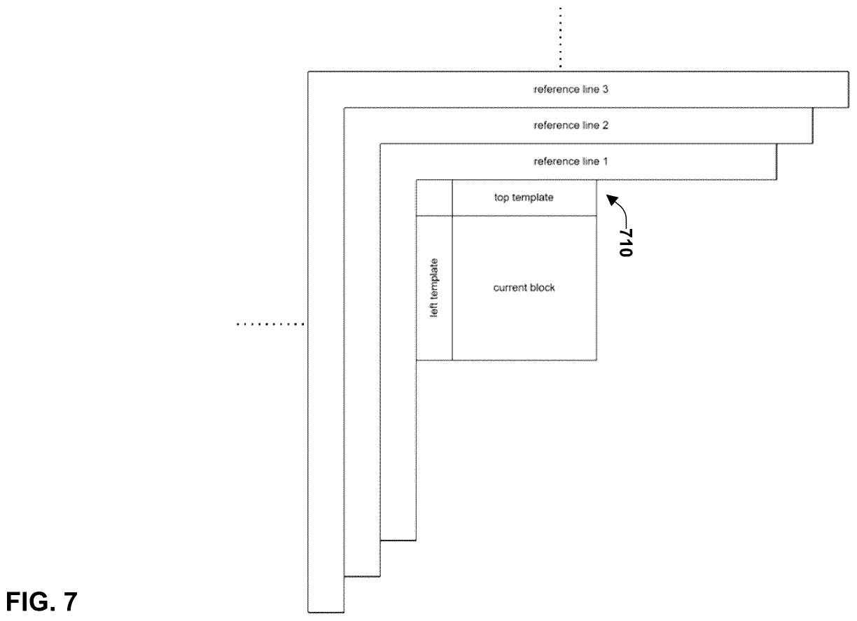

The TMRL candidate is constructed as follows. There are 5×10=50 combinations of the extended reference lines {1, 3, 5, 7, 12} and the allowed intra-prediction modes for a block. Since the extended reference line starts from reference line 1, the area covered by reference line 0 is used for template matching. The sum of absolute differences (SAD) costs over the template area 710 (as shown in FIG. 7) are calculated between the predictions (generated by 50 combinations) and the reconstructions. The 20 combinations with the least SAD cost are selected in an ascending order to form the TMRL candidate list. An index to the TMRL candidate list is coded to indicate which combination of reference line and prediction mode is used for coding the current block.

Intra Template Matching (intraTMP)

Intra template matching prediction (IntraTMP) is a special intra prediction mode that copies the best prediction block from the reconstructed part of the current frame, whose L-shaped template matches the current template. For a predefined search range, video encoder 200 searches for the most similar template to the current template in a reconstructed part of the current frame and uses the corresponding block as a prediction block. Video encoder 200 then signals the usage of this mode, and the same prediction operation is performed at video decoder 300.

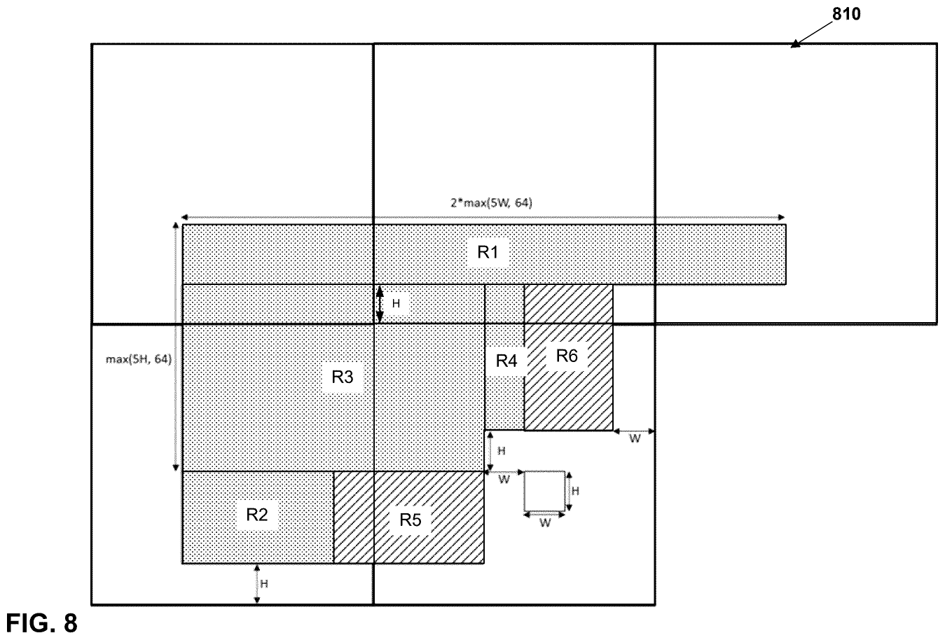

The prediction signal is generated by matching the L-shaped, Top-only or Left-only causal neighbor of the current block with another block in a predefined search, as shown in FIG. 8. FIG. 8 illustrates one example of intra template matching (intraTMP) 810 that may be used in conjunction with the techniques of this disclosure.

### IntraTMP Fusion

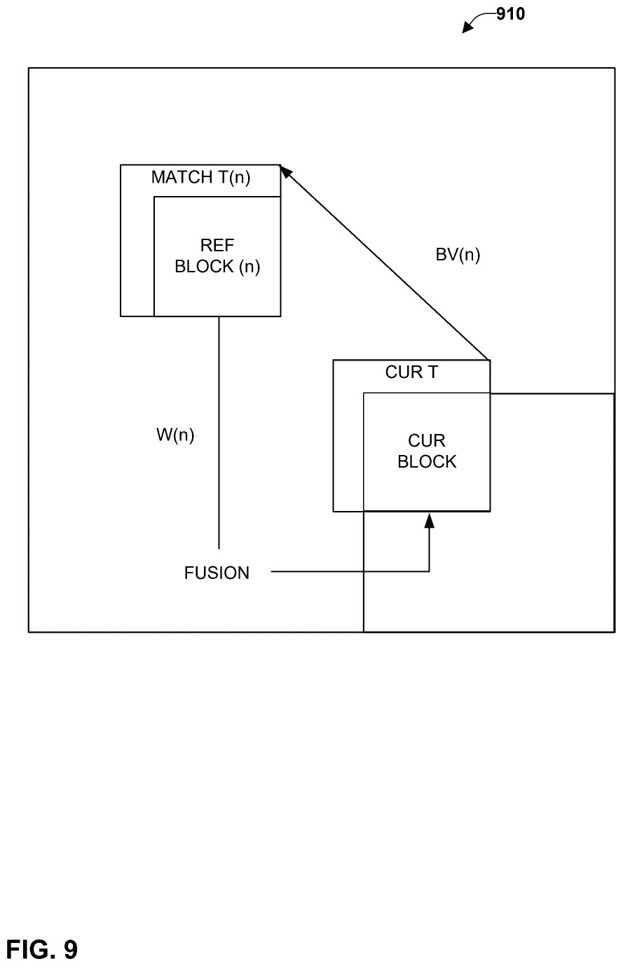

Multiple prediction blocks, e.g., the reference blocks (n), as shown in FIG. 9 (n=0, 1, . . . ), from the reconstructed part of the current frame are derived by intraTMP searching process. FIG. 9 illustrates one example of intraTMP fusion 910 that may be used in conjunction with the techniques of this disclosure. Multiple predictors are then blended to derive the final prediction block. The blending weights, e.g., w(n) as shown below (n=0, 1, . . . ), are either computed from the template matching cost of each predictor, or with Wiener-filter based weight derivation method. Additional details can be found in L. Zhang, et. al. “EE2-1.11: Intra template matching prediction fusion,” Joint Video Experts Team (JVET) of ITU-T SG 16 WP 3 and ISO/IEC JTC 1/SC 29, 30th Meeting, Antalya, TR, 21-28 Apr. 2023 (hereinafter, “JVET-AD0072”) and J. Ho, et. al. “EE2-1.16: A Fusion method of Intra Template Matching Prediction (Intra TMP),” Joint Video Experts Team (JVET) of ITU-T SG 16 WP 3 and ISO/IEC JTC 1/SC 29, 30th Meeting, Antalya, TR, 21-28 Apr. 2023 (hereinafter, “JVET-AD0116”).

### Intra TMP Linear Filter Model

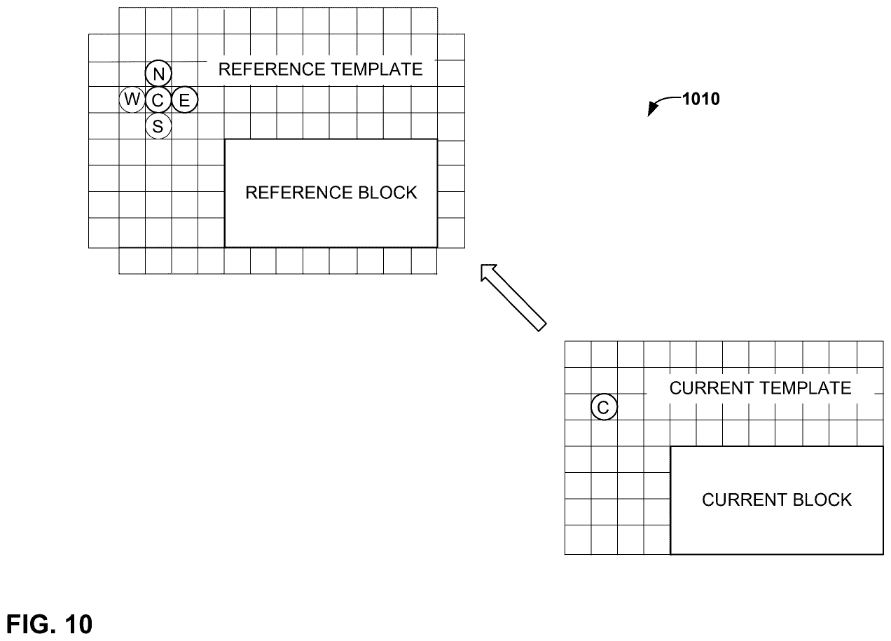

A linear filter can be learned between the reference template and current template and be applied the linear model to reference block, as shown in FIG. 10. FIG. 10 illustrates one example of an intraTMP linear filter model 1010 that may be used in conjunction with the techniques of this disclosure. This mode can be used for single predictor, i.e., intraTMP without fusion, when sub-pel precision is not used. Additional details can be found in J. Huo, et. al. “EE2-1.115a: Intra template matching (Intra TMP) based on linear filter model,” Joint Video Experts Team (JVET) of ITU-T SG 16 WP 3 and ISO/IEC JTC 1/SC 29, 30th Meeting, Antalya, TR, 21-28 Apr. 2023 (hereinafter, “JVET-AD0112”).

### IntraTMP Sub-pel Precision

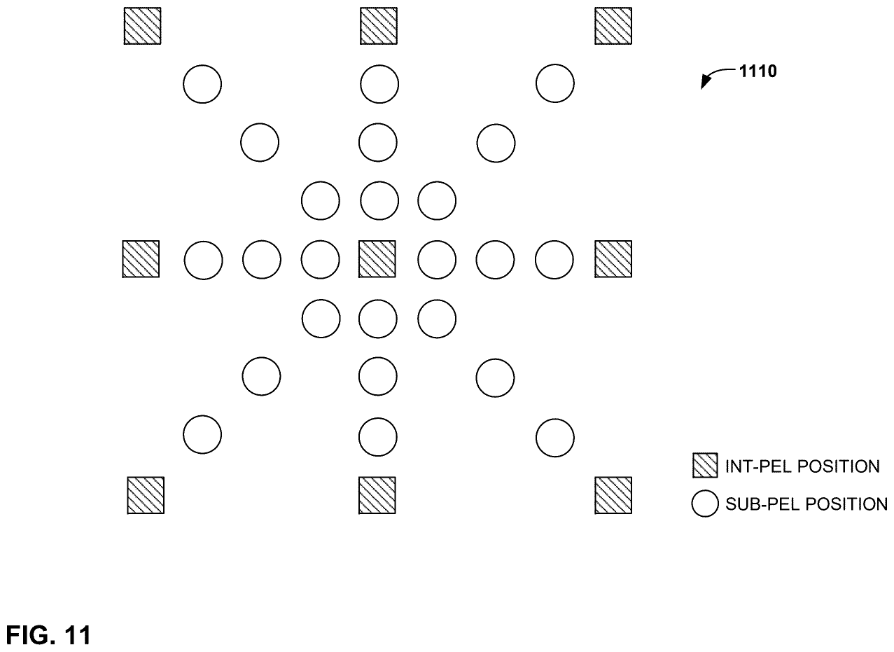

When single predictor (intraTMP without fusion) is used, sub-pel precision can be used with ½-pel precision, ¼-pel precision and ¾-pel precision, each with 8 possible directions as shown in FIG. 11. FIG. 11 illustrates one example of an intraTMP sub-pel precision 1110 that may be used in conjunction with the techniques of this disclosure. Additional details can be found in X. Li, et. al., “EE2-1.12: Intra TMP with sub-pel precision,” Joint Video Experts Team (JVET) of ITU-T SG 16 WP 3 and ISO/IEC JTC 1/SC 29, 30^{th} Meeting, Antalya, TR, 21-28 Apr. 2023 (hereinafter, “JVET-AD0125”).

IntraTMP with Local Illumination Compensation

IntraTMP with local illumination compensation (LIC) is allowed in some examples. The following considerations may be taken:
1) Usage of LIC together with intraTMP fusion is allowed.
2) Top-only and Left-only template usage for LIC model determination is allowed for screen content coding. For camera-captured coding, only the top-left template is employed.
3) Multi Mode Linear Model (MMLM) is supported similarly to intra block copy LC (IBC-LIC), for screen content coding. Additional details can be found in F. Le Leannec, et. al., “EE2-1.5: IntraTMP extension to LIC,” Joint Video Experts Team (JVET) of ITU-T SG 16 WP 3 and ISO/IEC JTC 1/SC 29, 33rd Meeting, by teleconference, 17-26 Jan. 2024 (hereinafter, “JVET-AG0136”).

The behaviors between current blocks and neighboring blocks are highly correlated, and the mode selections may be similar or the same. Some example ECM techniques and traditional video codecs can merge an intra parameter (e.g., block vector (BV), intra prediction index, etc.) of a neighboring intra coded block to a current coding block.

The current version of ECM adopts many intra coding tools, such as intraTMP, DIMD, TIMD, TMRL, etc. These intra coding tools may use more than one intra parameters to reconstruct the predictions. For example, more than one intra prediction mode index and weighting factors in DIMD and TIMD, a set of intra prediction mode index and multiple reference line indexes in TMRL, more than one BV and weighting factors in intraTMP fusions, etc. However, ECM does not allow the merger of all intra data of an intra coded neighboring block to a current coding block. This disclosure describes techniques for merging some or all intra data from a selected neighboring block. In this way, intra prediction may be performed more efficiently when many different possible intra prediction modes may be used.

### Examples

In some examples, an intra coding tool may use at least two parameters (e.g., mode indexes, weighting factors, etc.) to derive the predictors. The mode indexes may indicate which intra angular modes are used, or which block vectors (BVs) are used. The weighting factors indicate how different predictors are combined with respective weighting factors for fusion. In one example, video encoder 200 and video decoder 300 may be configured to merge some or all intra data (e.g., two or more intra prediction parameters) used in a selected intra-coded neighboring block relative to a current coding block. Video encoder 200 and video decoder 300 may reuse the merged intra data (e.g., intra coding mode and related parameters for the intra coding mode) and perform the same intra prediction reconstruction process used in the selected neighboring block. The following examples show the intra data that a current block can reuse:
(1) If the neighboring block is coded with DIMD mode, the merged data may include intra prediction mode indexes derived by DIMD, weighting factors, and a location dependency index. Different merging data sets can be applied to this example of the disclosure. For example, the merged data may include intra prediction mode indexes derived by DIMD and weighting factors (e.g., without location dependency index).
(2) If the neighboring block is coded with TIMD mode, the merged data may include intra prediction mode indexes derived by TIMD and weighting factors. Different merging data sets can be applied to this example of the disclosure.
(3) If the neighboring block is coded with intraTMP fusion mode, the merged data may include BVs derived by an intraTMP search process, weighting factors, and LIC parameters. Different merging data sets can be applied to this example of the disclosure. For example, the merged data may include BVs derived by intraTMP search process and weighting factors (e.g., without LIC parameters).
(4) If the neighboring block is coded with intraTMP linear filter model, the merged data may include a set of BVs derived by an intraTMP search process and weighting factors. Different merging data sets can be applied to this example of the disclosure.
(5) If the neighboring block is coded with an intraTMP interpolation filter, the merged data may include a set of BVs derived by intraTMP search process, pixel precision, and a direction index. Different merging data sets can be applied to this example of the disclosure.
(6) If the neighboring block is coded with TMRL, the merged data may include a set of intra prediction mode indexes and multiple reference line indexes. Different merging data sets can be applied this example of the disclosure.

Video encoder 200 may encode (or video decoder 300 may decode) a syntax element to signal the use of intra merge mode. In one instance, the syntax element can correspond to an intra merge flag to indicate whether to enable intra merge mode. If the flag is true, a candidate list is constructed, where each candidate stores the intra data that are used in the checked neighboring block. The checked neighboring blocks are those around the current block that have already been decoded or reconstructed. In another example, before signalling the intra merge flag, video encoder 200 may signal (or video decoder 300 may decode) a general derivation flag to indicate if the modes in a current CU include a mode that is derived from neighboring block, such as DIMD, OBIC, and the proposed intra merge mode. If this general derivation flag is true, several sub-derivation flags (such as OBIC flag, and intra merge flag) may further be signalled to indicate which intra derivation mode is used.

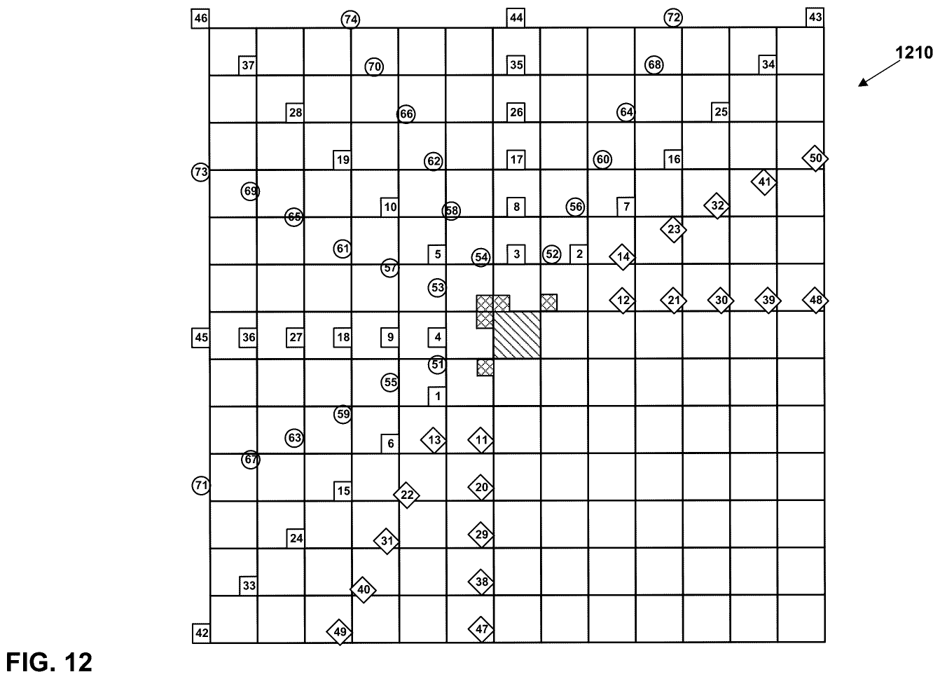

FIG. 12 shows an example of the checked neighboring blocks 1210, which are composed of adjacent blocks (e.g., directly adjacent to the center block) and non-adjacent blocks (e.g., the squares, circles, and diamonds with numbers), and the checking order is predefined. The neighboring blocks are checked until the list is full. The list size is a pre-assigned positive number.

In another example, a group of history-based candidates constructs the candidate list from a history candidate list. The history candidate list, which has a fixed size, follows a first-in, first-out (FIFO) storage process to store the intra data from a current coding block. Video encoder 200 and video decoder 300 may remove a candidate that was first stored in the current history candidate list. In another example, the process can add derived candidates to the list. The derived candidates are those derived from existing candidates. For example, a derived DIMD candidate is derived from existing DIMD candidates in the list by recalculating occurring numbers of intra prediction modes to derive intra prediction mode indexes and the weighting factors.

The candidate comparison is applied during list construction to check if the candidate is the same as one of existing candidates in the list. If it is not the same as any existing candidates, it is added to the list.

In one example, a coding process adds candidates from the neighboring blocks coded by different kinds of intra coding modes, such as DIMD, TIMD, intraTMP fusion, etc. into one list. In another example, there are several candidate lists, each of which is constructed by one kind of intra modes (or one group of intra modes). One or more flags may be signalled to indicate which candidate list is used by the current coding block. As one example, there may be two candidate lists, where one is constructed by DIMD coded neighboring blocks, and another is constructed by intraTMP fusion coded neighboring blocks. A flag may be signalled to indicate which list is used by current coding block.

In one example, a coding process selects candidates are from the neighboring blocks coded by different modes but share the same reconstruction process. For example, the candidates may be constructed by DIMD and TIMD modes. Both types of candidates may share the DIMD reconstruction process to generate the predictors. TIMD1 and TIMD2 may be limited to non-angular intra modes, in order to fit DIMD fusion reconstruction process, in which the first few modes are non-angular modes, and the last mode is Planar mode.

In one example, a coding process limits the proposed list to candidates storing intra data from the neighboring blocks coded by intra fusion tools, such as DIMD fusion, TIMD fusion, intraTMP fusion, and intraTMP Linear Filter Model. Each candidate stores at least two parameters of intra data from a neighboring block. In another example, the list can include the candidates storing at least two parameters of intra data, and candidates storing only one parameter.

In one example, the proposed intra prediction data merge mode of this disclosure is constrained by CU sizes. For example, the mode flag is bypassed if the CU area smaller than a preassigned positive value. In another one example, the proposed list size is dependent on the CU sizes. For example, there are several preassigned positive values to set larger list size if CU area is larger, and smaller list size if CU area is smaller.

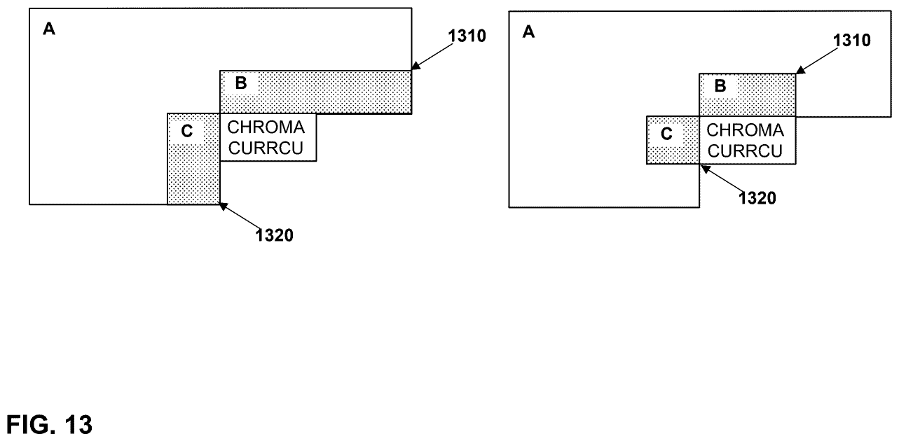

In another example of the disclosure, video encoder 200 and video decoder 300 may be configured to reorder the proposed list by template costs. In one example, the template can be composed of the neighboring blocks adjacent to the current chroma CU. In another one example, the template can be composed of other neighboring blocks not adjacent to the current chroma CU. Template B 1310 and Template C 1320 as shown in FIG. 13 are an example to form the template. The template could be a 1-pixel width. In another example, the width could be larger than 1 pixel.

In one example, the template cost is calculated by summing up the absolute value of the difference between the reconstructed sample in the template and the prediction value generated by the evaluated intra mode. In some other examples, the template cost can be calculated by other measurements, such as SATD cost, mean squared errors, etc.

In another example of the disclosure, video encoder 200 and video decoder 300 may be configured to bypass multiple transform selection (MTS) index signalling if the intra merge flag is true. More specifically, if the intra merge flag is true, video decoder 300 may derive the transform type with an inference (e.g., based on other video coding characteristics) without signalling. As one example, if the intra merge flag is true, video decoder 300 may derive the transform type depending on the transform block size. One example for this method is the horizontal transform type is derived to be a first transform type if the transform block is larger than a first predefined value or if the transform block is smaller than a second predefined value, where the first predefined value is larger than the second predefined value. The horizontal transform type is derived to be a second transform type if the transform block is smaller than or equal to the first predefined value and if the transform block is larger than or equal to the second predefined value. The same example can be applied to a vertical transform type. The first and second transform types can be DCT2, DST7, etc.

### Example Video Encoder and Decoder

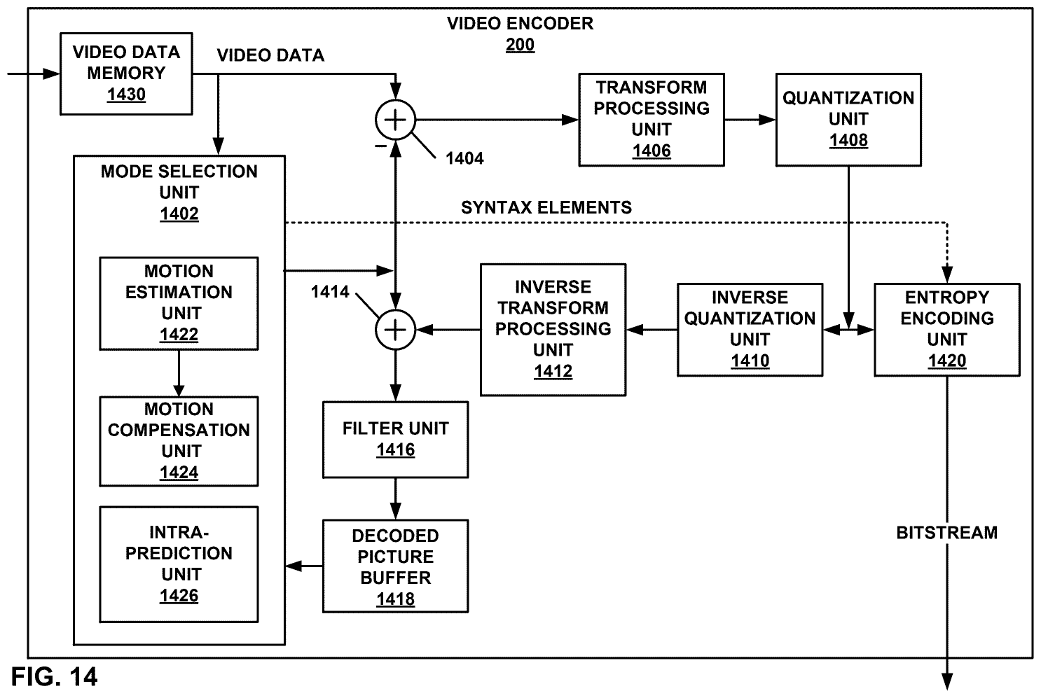

FIG. 14 is a block diagram illustrating an example video encoder 200 that may perform the techniques of this disclosure. FIG. 14 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 14, video encoder 200 includes video data memory 1430, mode selection unit 1402, residual generation unit 1404, transform processing unit 1406, quantization unit 1408, inverse quantization unit 1410, inverse transform processing unit 1412, reconstruction unit 1414, filter unit 1416, decoded picture buffer (DPB) 1418, and entropy encoding unit 1420. Any or all of video data memory 1430, mode selection unit 1402, residual generation unit 1404, transform processing unit 1406, quantization unit 1408, inverse quantization unit 1410, inverse transform processing unit 1412, reconstruction unit 1414, filter unit 1416, DPB 1418, and entropy encoding unit 1420 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 1430 is an example of a memory system that may store video data to be encoded by the components of video encoder 200. Video encoder 200 may receive the video data stored in video data memory 1430 from, for example, video source 104 (FIG. 1). DPB 1418 is an example of a memory system that may act as a reference picture memory that stores reference video data for use in prediction of subsequent video data by video encoder 200. Video data memory 1430 and DPB 1418 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 1430 and DPB 1418 may be provided by the same memory device or separate memory devices. In various examples, video data memory 1430 may be on-chip with other components of video encoder 200, as illustrated, or off-chip relative to those components.

In this disclosure, reference to video data memory 1430 should not be interpreted as being limited to memory internal to video encoder 200, unless specifically described as such, or memory external to video encoder 200, unless specifically described as such. Rather, reference to video data memory 1430 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 14 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 1430 is configured to store received video data. Video encoder 200 may retrieve a picture of the video data from video data memory 1430 and provide the video data to residual generation unit 1404 and mode selection unit 1402. Video data in video data memory 1430 may be raw video data that is to be encoded.

Mode selection unit 1402 includes a motion estimation unit 1422, a motion compensation unit 1424, and an intra-prediction unit 1426. Mode selection unit 1402 may include additional functional units to perform video prediction in accordance with other prediction modes. As examples, mode selection unit 1402 may include a palette unit, an intra-block copy unit (which may be part of motion estimation unit 1422 and/or motion compensation unit 1424), an affine unit, a linear model (LM) unit, or the like.

Mode selection unit 1402 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUs, and so on. Mode selection unit 1402 may ultimately select the combination of encoding parameters having rate-distortion values that are better than the other tested combinations.

Video encoder 200 may partition a picture retrieved from video data memory 1430 into a series of CTUs and encapsulate one or more CTUs within a slice. Mode selection unit 1402 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 1402 also controls the components thereof (e.g., motion estimation unit 1422, motion compensation unit 1424, and intra-prediction unit 1426) to generate a prediction block for a current block (e.g., a current CU, or in HEVC, the overlapping portion of a PU and a TU). For inter-prediction of a current block, motion estimation unit 1422 may perform a motion search to identify one or more closely matching reference blocks in one or more reference pictures (e.g., one or more previously coded pictures stored in DPB 1418). In particular, motion estimation unit 1422 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 1422 may generally perform these calculations using sample-by-sample differences between the current block and the reference block being considered. Motion estimation unit 1422 may identify a reference block having a lowest value resulting from these calculations, indicating a reference block that most closely matches the current block.

Motion estimation unit 1422 may form one or more motion vectors (MVs) that define the positions of the reference blocks in the reference pictures relative to the position of the current block in a current picture. Motion estimation unit 1422 may then provide the motion vectors to motion compensation unit 1424. For example, for uni-directional inter-prediction, motion estimation unit 1422 may provide a single motion vector, whereas for bi-directional inter-prediction, motion estimation unit 1422 may provide two motion vectors. Motion compensation unit 1424 may then generate a prediction block using the motion vectors. For example, motion compensation unit 1424 may retrieve data of the reference block using the motion vector. As another example, if the motion vector has fractional sample precision, motion compensation unit 1424 may interpolate values for the prediction block according to one or more interpolation filters. Moreover, for bi-directional inter-prediction, motion compensation unit 1424 may retrieve data for two reference blocks identified by respective motion vectors and combine the retrieved data, e.g., through sample-by-sample averaging or weighted averaging.

When operating according to the AV1 video coding format, motion estimation unit 1422 and motion compensation unit 1424 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 1426 may generate the prediction block from samples neighboring the current block. For example, for directional modes, intra-prediction unit 1426 may generally mathematically combine values of neighboring samples and populate these calculated values in the defined direction across the current block to produce the prediction block. As another example, for DC mode, intra-prediction unit 1426 may calculate an average of the neighboring samples to the current block and generate the prediction block to include this resulting average for each sample of the prediction block.

When operating according to the AV1 video coding format, intra-prediction unit 1426 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 1402 may include additional functional units to perform video prediction in accordance with other prediction modes.

Mode selection unit 1402 provides the prediction block to residual generation unit 1404. Residual generation unit 1404 receives a raw, unencoded version of the current block from video data memory 1430 and the prediction block from mode selection unit 1402. Residual generation unit 1404 calculates sample-by-sample differences between the current block and the prediction block. The resulting sample-by-sample differences define a residual block for the current block. In some examples, residual generation unit 1404 may also determine differences between sample values in the residual block to generate a residual block using residual differential pulse code modulation (RDPCM). In some examples, residual generation unit 1404 may be formed using one or more subtractor circuits that perform binary subtraction.

In examples where mode selection unit 1402 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2NxnU, 2NxnD, nLx2N, and nRx2N for inter prediction.

In examples where mode selection unit 1402 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 1402, via respective units associated with the coding techniques, generates a prediction block for the current block being encoded. In some examples, such as palette mode coding, mode selection unit 1402 may not generate a prediction block, and instead generate syntax elements that indicate the manner in which to reconstruct the block based on a selected palette. In such modes, mode selection unit 1402 may provide these syntax elements to entropy encoding unit 1420 to be encoded.

As described above, residual generation unit 1404 receives the video data for the current block and the corresponding prediction block. Residual generation unit 1404 then generates a residual block for the current block. To generate the residual block, residual generation unit 1404 calculates sample-by-sample differences between the prediction block and the current block.

Transform processing unit 1406 applies one or more transforms to the residual block to generate a block of transform coefficients (referred to herein as a “transform coefficient block”). Transform processing unit 1406 may apply various transforms to a residual block to form the transform coefficient block. For example, transform processing unit 1406 may apply a discrete cosine transform (DCT), a directional transform, a Karhunen-Loeve transform (KLT), or a conceptually similar transform to a residual block. In some examples, transform processing unit 1406 may perform multiple transforms to a residual block, e.g., a primary transform and a secondary transform, such as a rotational transform. In some examples, transform processing unit 1406 does not apply transforms to a residual block.

When operating according to AV1, transform processing unit 1406 may apply one or more transforms to the residual block to generate a block of transform coefficients (referred to herein as a “transform coefficient block”). Transform processing unit 1406 may apply various transforms to a residual block to form the transform coefficient block. For example, transform processing unit 1406 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 1408 may quantize the transform coefficients in a transform coefficient block, to produce a quantized transform coefficient block. Quantization unit 1408 may quantize transform coefficients of a transform coefficient block according to a quantization parameter (QP) value associated with the current block. Video encoder 200 (e.g., via mode selection unit 1402) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 1406.

Inverse quantization unit 1410 and inverse transform processing unit 1412 may apply inverse quantization and inverse transforms to a quantized transform coefficient block, respectively, to reconstruct a residual block from the transform coefficient block. Reconstruction unit 1414 may produce a reconstructed block corresponding to the current block (albeit potentially with some degree of distortion) based on the reconstructed residual block and a prediction block generated by mode selection unit 1402. For example, reconstruction unit 1414 may add samples of the reconstructed residual block to corresponding samples from the prediction block generated by mode selection unit 1402 to produce the reconstructed block.

Filter unit 1416 may perform one or more filter operations on reconstructed blocks. For example, filter unit 1416 may perform deblocking operations to reduce blockiness artifacts along edges of CUs. Operations of filter unit 1416 may be skipped, in some examples.

When operating according to AV1, filter unit 1416 may perform one or more filter operations on reconstructed blocks. For example, filter unit 1416 may perform deblocking operations to reduce blockiness artifacts along edges of CUs. In other examples, filter unit 1416 may apply a constrained directional enhancement filter (CDEF), which may be applied after deblocking, and may include the application of non-separable, non-linear, low-pass directional filters based on estimated edge directions. Filter unit 1416 may also include a loop restoration filter, which is applied after CDEF, and may include a separable symmetric normalized Wiener filter or a dual self-guided filter.

Video encoder 200 stores reconstructed blocks in DPB 1418. For instance, in examples where operations of filter unit 1416 are not performed, reconstruction unit 1414 may store reconstructed blocks to DPB 1418. In examples where operations of filter unit 1416 are performed, filter unit 1416 may store the filtered reconstructed blocks to DPB 1418. Motion estimation unit 1422 and motion compensation unit 1424 may retrieve a reference picture from DPB 1418, formed from the reconstructed (and potentially filtered) blocks, to inter-predict blocks of subsequently encoded pictures. In addition, intra-prediction unit 1426 may use reconstructed blocks in DPB 1418 of a current picture to intra-predict other blocks in the current picture.

In general, entropy encoding unit 1420 may entropy encode syntax elements received from other functional components of video encoder 200. For example, entropy encoding unit 1420 may entropy encode quantized transform coefficient blocks from quantization unit 1408. As another example, entropy encoding unit 1420 may entropy encode prediction syntax elements (e.g., motion information for inter-prediction or intra-mode information for intra-prediction) from mode selection unit 1402. Entropy encoding unit 1420 may perform one or more entropy encoding operations on the syntax elements, which are another example of video data, to generate entropy-encoded data. For example, entropy encoding unit 1420 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 1420 may operate in bypass mode where syntax elements are not entropy encoded.

Video encoder 200 may output a bitstream that includes the entropy encoded syntax elements needed to reconstruct blocks of a slice or picture. In particular, entropy encoding unit 1420 may output the bitstream.

In accordance with AV1, entropy encoding unit 1420 may be configured as a symbol-to-symbol adaptive multi-symbol arithmetic coder. A syntax element in AV1 includes an alphabet of N elements, and a context (e.g., probability model) includes a set of N probabilities. Entropy encoding unit 1420 may store the probabilities as n-bit (e.g., 15-bit) cumulative distribution functions (CDFs). Entropy encoding unit 1420 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine, based on an intra merge mode, coding modes from one or more neighboring intra coded blocks of a current block, wherein at least a first coding mode of the coding modes from a first neighboring block comprises two or more parameters, generate, based on the intra merge mode, a merge candidate list comprising the coding modes from the one or more neighboring intra coded blocks, the merge candidate list storing the two or more parameters of the first coding mode from the first neighboring block, select the first coding mode from the merge candidate list, and code the current block utilizing the first coding mode and the two or more parameters.

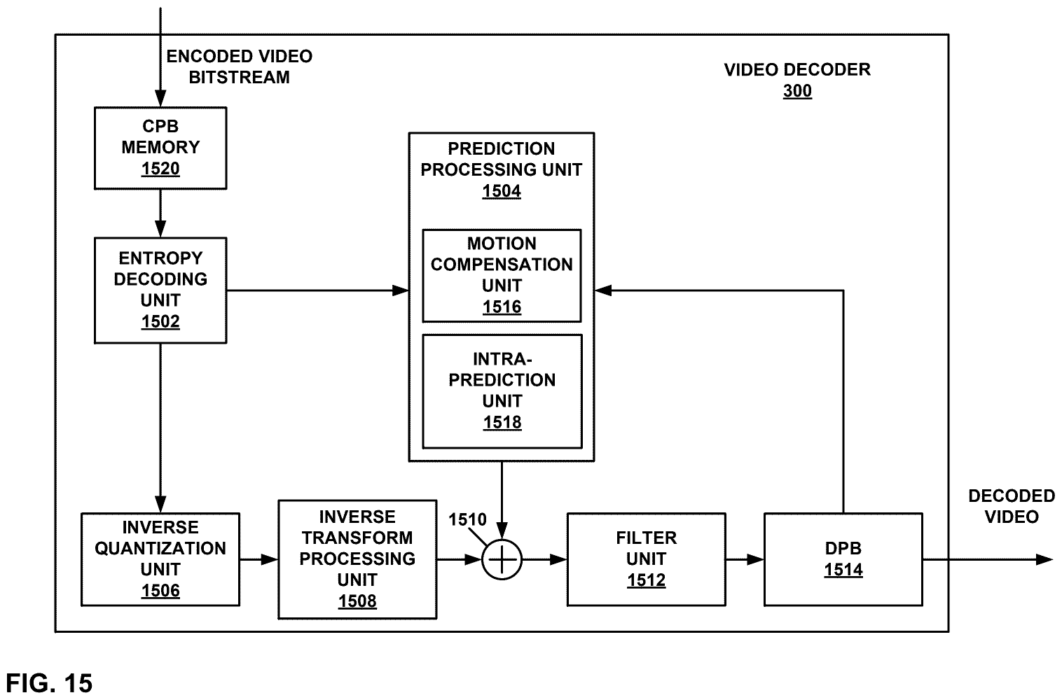

FIG. 15 is a block diagram illustrating an example video decoder 300 that may perform the techniques of this disclosure. FIG. 15 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 15, video decoder 300 includes coded picture buffer (CPB) memory 1520, entropy decoding unit 1502, prediction processing unit 1504, inverse quantization unit 1506, inverse transform processing unit 1508, reconstruction unit 1510, filter unit 1512, and DPB 1514. Any or all of CPB memory 1520, entropy decoding unit 1502, prediction processing unit 1504, inverse quantization unit 1506, inverse transform processing unit 1508, reconstruction unit 1510, filter unit 1512, and DPB 1514 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 1504 includes motion compensation unit 1516 and intra-prediction unit 1518. Prediction processing unit 1504 may include additional units to perform prediction in accordance with other prediction modes. As examples, prediction processing unit 1504 may include a palette unit, an intra-block copy unit (which may form part of motion compensation unit 1516), an affine unit, a linear model (LM) unit, or the like. In other examples, video decoder 300 may include more, fewer, or different functional components.

When operating according to AV1, motion compensation unit 1516 may be configured to decode coding blocks of video data (e.g., both luma and chroma coding blocks) using translational motion compensation, affine motion compensation, OBMC, and/or compound inter-intra prediction, as described above. Intra-prediction unit 1518 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 1520 is an example of a memory system that may store video data, such as an encoded video bitstream, to be decoded by the components of video decoder 300. The video data stored in CPB memory 1520 may be obtained, for example, from computer-readable medium 110 (FIG. 1). CPB memory 1520 may include a CPB that stores encoded video data (e.g., syntax elements) from an encoded video bitstream. Also, CPB memory 1520 may store video data other than syntax elements of a coded picture, such as temporary data representing outputs from the various units of video decoder 300. DPB 1514 is an example of a memory system that generally stores decoded pictures, which video decoder 300 may output and/or use as reference video data when decoding subsequent data or pictures of the encoded video bitstream. CPB memory 1520 and DPB 1514 may each be formed by any of a variety of memory devices or memory units, such as DRAM, including SDRAM, MRAM, RRAM, or other types of memory devices. CPB memory 1520 and DPB 1514 may be provided by the same memory device or separate memory devices. In various examples, CPB memory 1520 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 1520. Likewise, memory 120 may store instructions to be executed by video decoder 300, when some or all of the functionality of video decoder 300 is implemented in software to be executed by processing circuitry of video decoder 300.

The various units shown in FIG. 15 are illustrated to assist with understanding the operations performed by video decoder 300. The units may be implemented as fixed-function circuits, programmable circuits, or a combination thereof. Similar to FIG. 14, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 1502 may receive encoded video data from the CPB and entropy decode the video data to reproduce syntax elements. Prediction processing unit 1504, inverse quantization unit 1506, inverse transform processing unit 1508, reconstruction unit 1510, and filter unit 1512 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 1502 may entropy decode syntax elements defining quantized transform coefficients of a quantized transform coefficient block, as well as transform information, such as a quantization parameter (QP) and/or transform mode indication(s). Inverse quantization unit 1506 may use the QP associated with the quantized transform coefficient block to determine a degree of quantization and, likewise, a degree of inverse quantization for inverse quantization unit 1506 to apply. Inverse quantization unit 1506 may, for example, perform a bitwise left-shift operation to inverse quantize the quantized transform coefficients. Inverse quantization unit 1506 may thereby form a transform coefficient block including transform coefficients.

After inverse quantization unit 1506 forms the transform coefficient block, inverse transform processing unit 1508 may apply one or more inverse transforms to the transform coefficient block to generate a residual block associated with the current block. For example, inverse transform processing unit 1508 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 1504 generates a prediction block according to prediction information syntax elements that were entropy decoded by entropy decoding unit 1502. For example, if the prediction information syntax elements indicate that the current block is inter-predicted, motion compensation unit 1516 may generate the prediction block. In this case, the prediction information syntax elements may indicate a reference picture in DPB 1514 from which to retrieve a reference block, as well as a motion vector identifying a location of the reference block in the reference picture relative to the location of the current block in the current picture. Motion compensation unit 1516 may generally perform the inter-prediction process in a manner that is substantially similar to that described with respect to motion compensation unit 224 (FIG. 14).

As another example, if the prediction information syntax elements indicate that the current block is intra-predicted, intra-prediction unit 1518 may generate the prediction block according to an intra-prediction mode indicated by the prediction information syntax elements. Again, intra-prediction unit 1518 may generally perform the intra-prediction process in a manner that is substantially similar to that described with respect to intra-prediction unit 226 (FIG. 14). Intra-prediction unit 1518 may retrieve data of neighboring samples to the current block from DB 1514.

Reconstruction unit 1510 may reconstruct the current block using the prediction block and the residual block. For example, reconstruction unit 1510 may add samples of the residual block to corresponding samples of the prediction block to reconstruct the current block.

Filter unit 1512 may perform one or more filter operations on reconstructed blocks. For example, filter unit 1512 may perform deblocking operations to reduce blockiness artifacts along edges of the reconstructed blocks. Operations of filter unit 1512 are not necessarily performed in all examples.

Video decoder 300 may store the reconstructed blocks in DPB 1514. For instance, in examples where operations of filter unit 1512 are not performed, reconstruction unit 1510 may store reconstructed blocks to DPB 1514. In examples where operations of filter unit 1512 are performed, filter unit 1512 may store the filtered reconstructed blocks to DPB 1514. As discussed above, DPB 1514 may provide reference information, such as samples of a current picture for intra-prediction and previously decoded pictures for subsequent motion compensation, to prediction processing unit 1504. Moreover, video decoder 300 may output decoded pictures (e.g., decoded video) from DPB 1514 for subsequent presentation on a display device, such as display device 118 of FIG. 1. In this manner, video decoder 300 represents an example of a video decoding device including a memory configured to store video data, and one or more processing units implemented in circuitry and configured to determine, based on an intra merge mode, coding modes from one or more neighboring intra coded blocks of a current block, wherein at least a first coding mode of the coding modes from a first neighboring block comprises two or more parameters, generate, based on the intra merge mode, a merge candidate list comprising the coding modes from the one or more neighboring intra coded blocks, the merge candidate list storing the two or more parameters of the first coding mode from the first neighboring block, select the first coding mode from the merge candidate list, and code the current block utilizing the first coding mode and the two or more parameters.

### Example Coding Methods

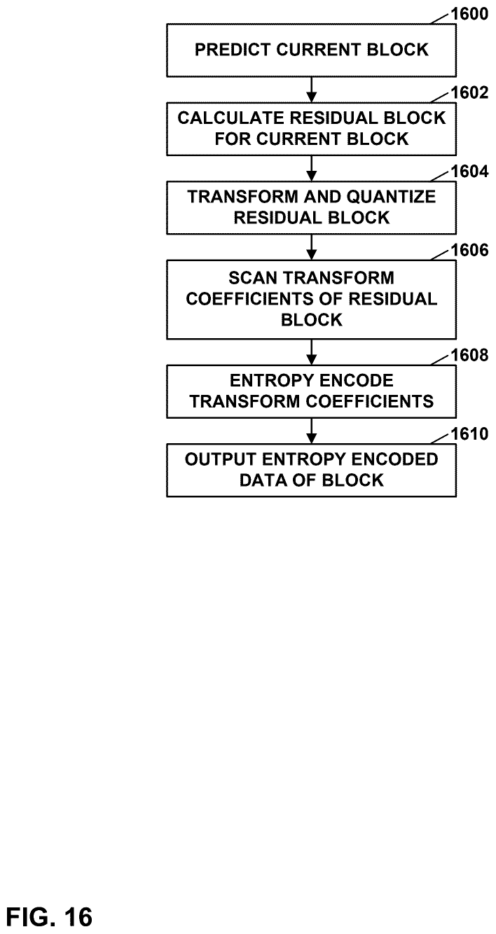

FIG. 16 is a flowchart illustrating an example method for encoding a current block in accordance with the techniques of this disclosure. The current block may be or include a current CU. Although described with respect to video encoder 200 (FIGS. 1 and 14), it should be understood that other devices may be configured to perform a method similar to that of FIG. 16.

In this example, video encoder 200 initially predicts the current block (1600). For example, video encoder 200 may form a prediction block for the current block. Video encoder 200 may then calculate a residual block for the current block (1602). To calculate the residual block, video encoder 200 may calculate a difference between the original, unencoded block and the prediction block for the current block. Video encoder 200 may then transform the residual block and quantize transform coefficients of the residual block (1604). Next, video encoder 200 may scan the quantized transform coefficients of the residual block (1606). During the scan, or following the scan, video encoder 200 may entropy encode the transform coefficients (1608). For example, video encoder 200 may encode the transform coefficients using CAVLC or CABAC. Video encoder 200 may then output the entropy encoded data of the block (1610).

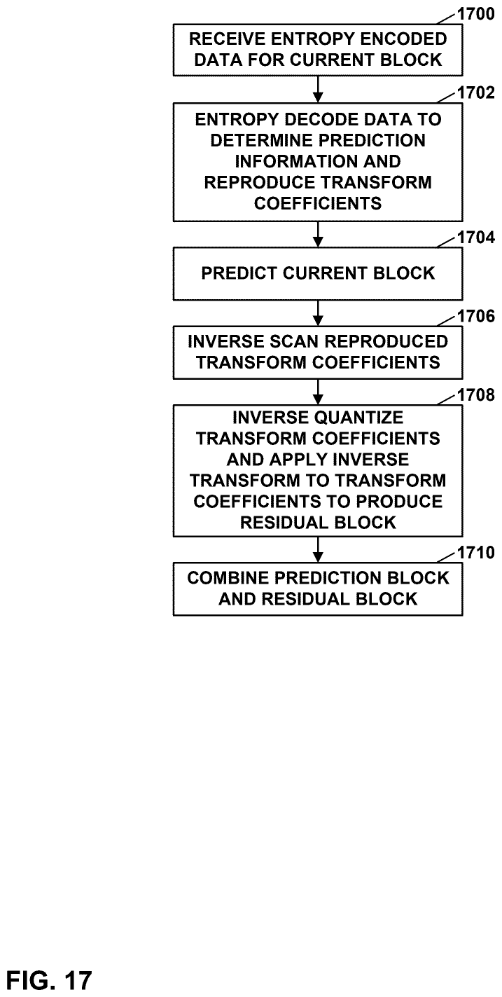

FIG. 17 is a flowchart illustrating an example method for decoding a current block of video data in accordance with the techniques of this disclosure. The current block may be or include a current CU. Although described with respect to video decoder 300 (FIGS. 1 and 15), it should be understood that other devices may be configured to perform a method similar to that of FIG. 17.

Video decoder 300 may receive entropy-encoded data for the current block, such as entropy-encoded prediction information and entropy-encoded data for transform coefficients of a residual block corresponding to the current block (1700). Video decoder 300 may entropy decode the entropy encoded data to determine prediction information for the current block and to reproduce transform coefficients of the residual block (1702). Video decoder 300 may predict the current block (1704), e.g., using an intra- or inter-prediction mode as indicated by the prediction information for the current block, to calculate a prediction block for the current block. Video decoder 300 may then inverse scan the reproduced transform coefficients (1706), to create a block of quantized transform coefficients. Video decoder 300 may then inverse quantize the transform coefficients and apply an inverse transform to the transform coefficients to produce a residual block (1708). Video decoder 300 may ultimately decode the current block by combining the prediction block and the residual block (1710).

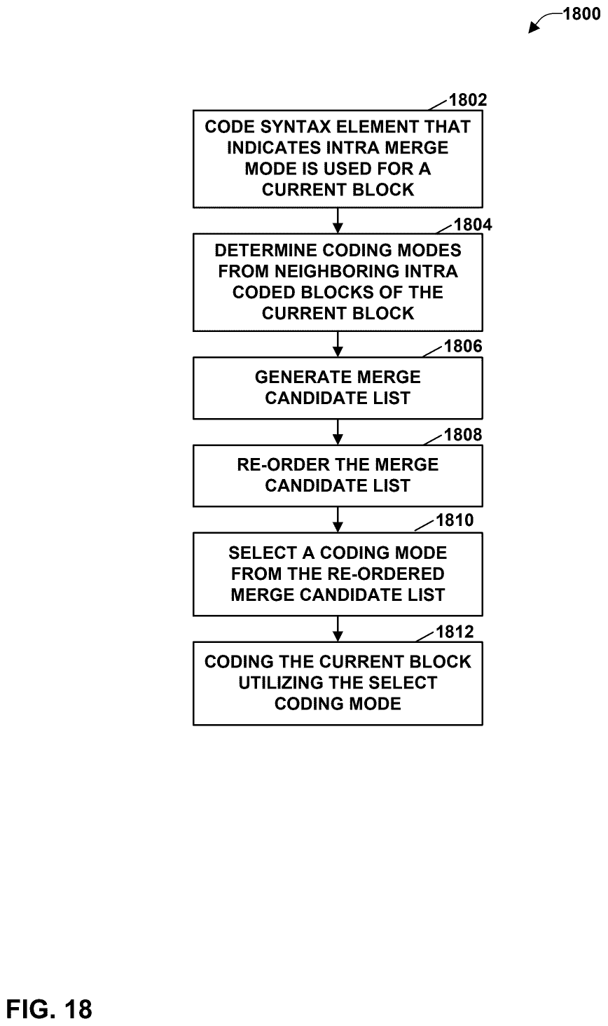

FIG. 18 is a flowchart illustrating an example method 1800 for coding a current block of video data in accordance with the techniques of this disclosure. The current block may be or include a current CU. Aspects can be performed by video encoder 200 of FIG. 1 and FIG. 14 as well as by video decoder 300 of FIG. 1 and FIG. 15. More specifically, aspects may be performed by intra-prediction unit 1426 of video encoder 200 and intra-prediction unit 1518 of video decoder 300. Although disclosed aspects can be performed by video encoder 200 and video decoder 300, other devices may be configured to perform a method similar to that of FIG. 18.

Example method 1800 begins at block 1802 with coding a syntax element that indicates intra merge mode is used for a current block. In accordance with one aspect, the syntax element can correspond to a flag that can be set when intra merge mode is to be used and unset when intra merge mode is not to be used. Regardless of implementation, the syntax element can be employed to active intra merge mode for a current block.

Example method 1800 continues at block 1804 with determining coding modes from neighboring intra coded blocks of the current block. By way of example, FIG. 12 illustrates a current block surrounded by neighboring blocks on two sides with small squares corresponding to intra data including coding modes. In accordance with one aspect, a first coding mode may utilize two or more parameters.

Example method 1800 continues at block 1806 with generating a merge candidate list comprising coding modes from neighboring intra coded blocks of the current block including coding modes with multiple parameters. In accordance with one aspect, the merge candidate list can comprise multiple types of intra-prediction modes. Further, multiple merge candidate lists can be generated for each type of intra-prediction mode, such that an additional index or the like is passed to identify a particular merge candidate list.

Example method 1800 continues at block 1808 with re-ordering the merge candidate list. In accordance with one aspect, template costs can be computed for each coding mode in the merge candidate list. A template cost can be a measure of how well a coding mode prediction values match reconstructed video samples. The merge candidate list can be re-ordered based on the cost, for example such that coding modes with having lower costs (e.g., providing better predictions) are higher or near the front of the merge candidate list. Re-ordering enables more optimal selection of a coding mode for a current video block and helps ensure that the “best” coding mode based on template cost are more likely to be selected for final coding. Consequently, overall coding efficiency and video quality are improved.

Example method 1800 next proceeds to block 1810 with selecting a coding mode from the re-ordered merge candidate list. For example, the first coding mode may be selected. The selection can be based on the template cost for an encoder, among other things. In accordance with one aspect, an encoder can encode and transmit an index in the re-ordered merge candidate list corresponding to the selected coding mode. A decoder can generate the re-ordered merge candidate list, decode the index, and use the index to select the coding mode.

Example method 1800 continues next at block 1812, with coding the current block utilizing the select coding mode. In one instance, such coding can correspond to encoding a current block or decoding a current block.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

### Example Clauses

Implementation examples are described in the following numbered clauses:

Clause 1: A method of coding video data, the method comprising: determining, based on an intra merge mode, coding modes from one or more neighboring intra coded blocks of a current block, wherein at least a first coding mode of the coding modes from a first neighboring block comprises two or more parameters; generating, based on the intra merge mode, a merge candidate list comprising the coding modes from the one or more neighboring intra coded blocks, the merge candidate list storing the two or more parameters of the first coding mode from the first neighboring block; selecting the first coding mode from the merge candidate list; and coding the current block utilizing the first coding mode and the two or more parameters.

Clause 2: The method of Clause 1, wherein the first coding mode is decoder side intra mode derivation (DIMD), and wherein the two or more parameters include two or more of intra prediction mode indexes derived using DIMD, weighting factors, or a location dependency index.

Clause 3: The method of Clauses 1-2, wherein the first coding mode is an intra template matching (intraTMP) fusion mode, and wherein the two or more parameters include two or more of block vectors derived using an intraTMP search process, weighting factors, or local illumination compensation (LIC) factors.

Clause 4: The method of Clauses 1-3, wherein the first coding mode is an intra template matching (intraTMP) linear filter model, and wherein the two or more parameters include two or more of a set of block vectors derived using an intraTMP search process, or weighting factors.

Clause 5: The method of Clauses 1-4, wherein the first coding mode is an intra template matching (intraTMP) interpolation filter, and wherein the two or more parameters include two or more of a set of block vectors derived using an intraTMP search process, pixel precision, or a direction index.

Clause 6: The method of Clauses 1-5, wherein the first coding mode is a template-based multiple reference line prediction (TMRL) mode, and wherein the two or more parameters include two or more of a set of intra prediction mode index, or multiple reference line indexes.

Clause 7: The method of Clauses 1-6, wherein the coding modes in the merge candidate list includes multiple types of intra prediction modes.

Clause 8: The method of Clauses 1-7, wherein generating, based on the intra merge mode, the merge candidate list comprising the coding modes comprises: generating a first merge candidate list for a first type of intra prediction mode; and generating a second merge candidate list for a second type of intra prediction mode.

Clause 9: The method of Clauses 1-8, further comprising reordering the coding modes in the merge candidate list based on a template cost.

Clause 10: The method of Clauses 1-9, wherein coding the current block utilizing the first coding mode comprises encoding the current block utilizing the first coding mode.

Clause 11: The method of Clauses 1-10, wherein the coding the current block utilizing the first coding mode comprises decoding the current block utilizing the first coding mode.

Clause 12: The method of Clauses 1-11, further comprising coding a syntax element that indicates that an intra merge mode is used for the current block.

Clause 13: The method of Clauses 1-12, further comprising determining, based on the syntax element indicating the intra merge mode is used, a transform type for the current block based on a transform block size.

Clause 14: An apparatus configured to code video data, the apparatus comprising: one or more memories; processing circuitry in communication with the one or more memories, the processing circuitry configured to: determine, based on an intra merge mode, coding modes from one or more neighboring intra coded blocks of a current block, wherein at a first coding mode of the coding modes from a first neighboring block comprises two or more parameters; generate, based on the intra merge mode, a merge candidate list comprising the coding modes from the one or more neighboring intra coded blocks, the merge candidate list storing the two or more parameters of the first coding mode from the first neighboring block; select the first coding mode from the merge candidate list; and code the current block utilizing the first coding mode and the two or more parameters.

Clause 15: The apparatus of Clause 14, wherein the processing circuitry is configured to code a syntax element that indicates that the intra merge mode is used for the current block.

Clause 16: The apparatus of Clauses 14-15, wherein the coding modes in the merge candidate list include multiple types of intra prediction modes.

Clause 17: The apparatus of Clauses 14-16, wherein generate, based on the intra merge mode, the merge candidate list comprising the coding modes comprises: generate a first merge candidate list for a first type of intra prediction mode; and generate a second merge candidate list for a second type of intra prediction mode.

Clause 18: The apparatus of Clauses 14-17, wherein code the current block utilizing the first coding mode comprises encode the current block utilizing the coding mode.

Clause 19: The apparatus of claims 14-17, wherein code the current block utilizing the first coding mode comprises decode the current block utilizing the first coding mode.

Clause 20: A non-transitory computer-readable storage medium having stored thereon instructions that, when executed, cause one or more processors to: determine, based on an intra merge mode, coding modes from one or more neighboring intra coded blocks of a current block, wherein at least a first coding mode of the coding modes comprises two or more parameters; generate, based on an intra merge mode, a merge candidate list comprising the coding modes from the one or more neighboring intra coded blocks, the merge candidate list storing the two or more parameters of the first coding mode from the first neighboring block; select the first coding mode from the merge candidate list; and code the current block utilizing the first coding mode and the two or more parameters.

Clause 21: An apparatus comprising: one or more memories; processing circuitry in communication with the one or more memories, the processing circuitry configured to perform a method in accordance with any one of Clauses 1-20.

Clause 22: A processing system, comprising: a memory comprising computer-executable instructions; and a processor configured to execute the computer-executable instructions and cause the processing system to perform a method in accordance with any one of Clauses 1-20.

Clause 23: A processing system, comprising means for performing a method in accordance with any one of Clauses 1-20.

Clause 24: A non-transitory computer-readable medium storing program code for causing a processing system to perform the steps of any one of Clauses 1-20.

Clause 25: A computer program product embodied on a computer-readable storage medium comprising code for performing a method in accordance with any one of Clauses 1-20.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of coding video data, the method comprising:
determining, based on an intra merge mode, coding modes from one or more neighboring intra coded blocks of a current block, wherein at least a first coding mode of the coding modes from a first neighboring block comprises two or more parameters;
generating, based on the intra merge mode, a merge candidate list comprising the coding modes from the one or more neighboring intra coded blocks, the merge candidate list storing the two or more parameters of the first coding mode from the first neighboring block;
selecting the first coding mode from the merge candidate list; and
coding the current block utilizing the first coding mode and the two or more parameters.

2. The method of claim 1, wherein the first coding mode is decoder side intra mode derivation (DIMD), and wherein the two or more parameters include two or more of intra prediction mode indexes derived using DIMD, weighting factors, or a location dependency index.

3. The method of claim 1, wherein the first coding mode is an intra template matching (intraTMP) fusion mode, and wherein the two or more parameters include two or more of block vectors derived using an intraTMP search process, weighting factors, or local illumination compensation (LIC) factors.

4. The method of claim 1, wherein the first coding mode is an intra template matching (intraTMP) linear filter model, and wherein the two or more parameters include two or more of a set of block vectors derived using an intraTMP search process, or weighting factors.

5. The method of claim 1, wherein the first coding mode is an intra template matching (intraTMP) interpolation filter, and wherein the two or more parameters include two or more of a set of block vectors derived using an intraTMP search process, pixel precision, or a direction index.

6. The method of claim 1, wherein the first coding mode is a template-based multiple reference line prediction (TMRL) mode, and wherein the two or more parameters include two or more of a set of intra prediction mode index, or multiple reference line indexes.

7. The method of claim 1, wherein the coding modes in the merge candidate list includes multiple types of intra prediction modes.

8. The method of claim 1, wherein generating, based on the intra merge mode, the merge candidate list comprising the coding modes comprises:
generating a first merge candidate list for a first type of intra prediction mode; and
generating a second merge candidate list for a second type of intra prediction mode.

9. The method of claim 1, further comprising reordering the coding modes in the merge candidate list based on a template cost.

10. The method of claim 1, wherein coding the current block utilizing the first coding mode comprises encoding the current block utilizing the first coding mode.

11. The method of claim 1, wherein the coding the current block utilizing the first coding mode comprises decoding the current block utilizing the first coding mode.

12. The method of claim 1, further comprising coding a syntax element that indicates that an intra merge mode is used for the current block.

13. The method of claim 12, further comprising determining, based on the syntax element indicating the intra merge mode is used, a transform type for the current block based on a transform block size.

14. An apparatus configured to decode video data, the apparatus comprising:
one or more memories;
processing circuitry in communication with the one or more memories, the processing circuitry configured to:
determine, based on an intra merge mode, coding modes from one or more neighboring intra coded blocks of a current block, wherein at a first coding mode of the coding modes from a first neighboring block comprises two or more parameters;
generate, based on the intra merge mode, a merge candidate list comprising the coding modes from the one or more neighboring intra coded blocks, the merge candidate list storing the two or more parameters of the first coding mode from the first neighboring block;
select the first coding mode from the merge candidate list; and
decode the current block utilizing the first coding mode and the two or more parameters.

15. The apparatus of claim 14, wherein the processing circuitry is further configured to decode a syntax element that indicates that the intra merge mode is used for the current block.

16. The apparatus of claim 14, wherein the coding modes in the merge candidate list include multiple types of intra prediction modes.

17. The apparatus of claim 14, wherein to generate, based on the intra merge mode, the merge candidate list comprising the coding modes, the processing circuitry is further configured to:
generate a first merge candidate list for a first type of intra prediction mode; and
generate a second merge candidate list for a second type of intra prediction mode.

18. An apparatus configured to encode video data, the apparatus comprising:
one or more memories;
processing circuitry in communication with one or more memories, the processing circuitry configured to:
determine, based on an intra merge mode, coding modes from one or more neighboring intra coded blocks of a current block, wherein at least a first coding mode of the coding modes comprises two or more parameters;
generate, based on an intra merge mode, a merge candidate list comprising the coding modes from the one or more neighboring intra coded blocks, the merge candidate list storing the two or more parameters of the first coding mode from the first neighboring block;
select the first coding mode from the merge candidate list; and
encode the current block utilizing the first coding mode and the two or more parameters.

19. The apparatus of claim 18, wherein the processing circuitry is further configured to encode a syntax element that indicates that the intra merge mode is used for the current block.

20. The apparatus of claim 18, wherein the coding modes in the merge candidate list include multiple types of intra prediction modes.
